(19) United States
(12) Patent Application Publication
(10) Pub. No.: US 2006/0165163 A1
(43) Pub. Date: Jul. 27, 2006

(54) Video encoding

(75) Inventors: Dzevdet Burazerovic, Eindhoven (NL); Gerardus Johannes Maria Vervoort, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/547,324

(22) PCT Filed: Feb. 25, 2004
(86) PCT No.: PCT/IB04/50145

§ 371 Date: Aug. 30, 2005

(30) Foreign Application Priority Data
Mar. 3, 2003 (EP) 03100520.0

(51) Int. Cl. H04N 11/04; H04N 7/12; H04B 1/66; H04N 11/02

(52) U.S. Cl. 375/240.03; 375/240.24; 375/240.12

(57) ABSTRACT

The invention relates to a video encoder (201) for encoding a video signal. The video encoder comprises a segmentation processor (207) which divides the picture into picture regions. Preferably, picture regions having a high degree of flatness or uniformity are determined in this way. A characteristics processor (209) determine a spatial frequency characteristic for each picture region, and a coding controller (211) selects an encoding block size, such as a prediction block size for motion estimation, in response to the spatial frequency characteristic. An encode processor (213) encodes the picture using the selected encoding block size. Specifically, increasing block sizes are selected for increasing degrees of uniformity or flatness indicated by the spatial frequency characteristic. Thereby, an increasing proportion of high frequency components and a consistent choice of encoding block sizes are maintained, and thus the coding artefacts from many encoders having variable prediction block sizes is reduced. The invention is particularly suitable for H.264 and similar encoders.

### FIELD OF THE INVENTION

The invention relates to a video encoder and method of video encoding therefore and in particular but not exclusively to video encoding in accordance with the H.264 video encoding standard.

### BACKGROUND OF THE INVENTION

In recent years, the use of digital storage and distribution of video signals have become increasingly prevalent. In order to reduce the bandwidth required to transmit digital video signals, it is well known to use efficient digital video encoding comprising video data compression whereby the data rate of a digital video signal may be substantially reduced.

In order to ensure interoperability, video encoding standards have played a key role in facilitating the adoption of digital video in many professional- and consumer applications. Most influential standards are traditionally developed by either the International Telecommunications Union (ITU-T) or the MPEG (Motion Pictures Experts Group) committee of the ISO/IEC (the International Organization for Standardization/the International Electrotechnical Committee). The ITU-T standards, known as recommendations, are typically aimed at real-time communications (e.g. videoconferencing), while most MPEG standards are optimized for storage (e.g. for Digital Versatile Disc (DVD)) and broadcast (e.g. for Digital Video Broadcast (DVB) standard).

Currently, one of the most widely used video compression techniques is known as the MPEG-2 (Motion Picture Expert Group) standard. MPEG-2 is a block based compression scheme wherein a frame is divided into a plurality of blocks each comprising eight vertical and eight horizontal pixels. For compression of luminance data, each block is individually compressed using a Discrete Cosine Transform (DCT) followed by quantization which reduces a significant number of the transformed data values to zero. For compression of chrominance data, the amount of chrominance data is usually first reduced by down-sampling, such that for each four luminance blocks two chrominance blocks are obtained (4:2:0 format), that are similarly compressed using the DCT and quantization. Frames based only on intra-frame compression are known as Intra Frames (I-Frames).

In addition to intra-frame compression, MPEG-2 uses inter-frame compression to further reduce the data rate. Inter-frame compression includes generation of predicted frames (P-frames) based on previous I-frames. In addition, I and P frames are typically interposed by Bidirectional predicted frames (B-frames), wherein compression is achieved by only transmitting the differences between the B-frame and surrounding I- and P-frames. In addition, MPEG-2 uses motion estimation wherein the image of macroblocks of one frame found in subsequent frames at different positions are communicated simply by use of a motion vector.

As a result of these compression techniques, video signals of standard TV studio broadcast quality level can be transmitted at data rates of around 24 Mbps.

Recently, a new ITU-T standard, known as H.26L, has emerged. H.26L is becoming broadly recognized for its superior coding efficiency in comparison with the existing standards such as MPEG-2. Although the gain of H.26L generally decreases in proportion to the picture size, the potential for its deployment in a broad range of applications is undoubted. This potential has been recognized through formation of the Joint Video Team (JVT) forum, which is responsible for finalizing H.26L as a new joint ITU-T/MPEG standard. The new standard is known as H.264 or MPEG-4 AVC (Advanced Video Coding).

Furthermore, H.264-based solutions are being considered in other standardization bodies, such as the DVB and DVD Forums.

The H.264 standard employs the same principles of block-based motion-compensated hybrid transform coding that are known from the established standards such as MPEG-2. The H.264 syntax is, therefore, organized as the usual hierarchy of headers, such as picture-, slice- and macro-block headers, and data, such as motion-vectors, block-transform coefficients, quantizer scale, etc. However, the H.264 standard separates the Video Coding Layer (VCL), which represents the content of the video data, and the Network Adaptation Layer (NAL), which formats data and provides header information.

Furthermore, H264 allows for a much increased choice of encoding parameters. For example, it allows for a more elaborate partitioning and manipulation of 16×16 macro-blocks whereby e.g. motion compensation process can be performed on segmentations of a macro-block as small as 4×4 in size. Also, the selection process for motion compensated prediction of a sample block may involve a number of stored previously-decoded pictures, instead of only the adjacent pictures. Even with intra coding within a single frame, it is possible to form a prediction of a block using previously-decoded samples from the same frame. Also, the resulting prediction error following motion compensation may be transformed and quantized based on a 4×4 block size, instead of the traditional 8×8 size.

The H.264 standard may be considered a superset of the MPEG-2 video encoding syntax in that it uses the same global structuring of video data, while extending the number of possible coding decisions and parameters. A consequence of having a variety of coding decisions is that a good trade-off between the bit rate and picture quality may be achieved. However, although it is commonly acknowledged that while the H.264 standard may significantly reduce typical artefacts of block-based coding, it can also accentuate other artefacts.

The fact that H.264 allows for an increased number of possible values for various coding parameters thus results in an increased potential for improving the encoding process but also results in increased sensitivity to the choice of video encoding parameters. Similarly to other standards, H.264 does not specify a normative procedure for selecting video encoding parameters, but describes through a reference implementation, a number of criteria that may be used to select video encoding parameters such as to achieve a suitable trade-off between coding efficiency, video quality and practicality of implementation.

However, the described criteria may not always result in an optimal or suitable selection of coding parameters. For example, the criteria may not result in selection of video encoding parameters optimal or desirable for the characteristics of the video signal, or the criteria may be based on attaining characteristics of the encoded signal which are not appropriate for the current application. For example, it is commonly acknowledged that while H.264 can significantly reduce some typical artefacts of MPEG-2 encoding, it can also cause other artefacts. One such artefact is a partial removal of texture, resulting in a plastic-like or smeared appearance of some picture areas. Another is coding artefacts creating coding noise in picture areas having a high degree of flatness. This is especially noticeable for larger picture formats, such as High Definition TV.

Accordingly, an improved system for video encoding would be advantageous and in particular an improved video encoding system exploiting the possibilities of emerging standards, such as H264, to improve video encoding is advantageous.

### SUMMARY OF THE INVENTION

Accordingly, the invention seeks to mitigate, alleviate or eliminate one or more of the above mentioned disadvantages singly or in any combination.

According to a first aspect of the invention, there is provided a video encoder for encoding a video signal comprising: means for determining a picture region having a spatial frequency characteristic; means for setting an encoding block size for the picture region in response to the spatial frequency characteristic; and means for encoding the video signal using the encoding block size for the picture region.

The invention allows for improved video encoding performance and in particular an improved video quality and/or reduced encoded data rate may be achieved. The inventors have realised that the preferred encoding block sizes depend on the spatial frequency characteristics. The invention allows for an improved quality and/or data rate to be achieved for a picture based on local adaptation of block encoding sizes based on local spatial frequency characteristics. A dynamic and local adaptation of block encoding sizes to suit local spatial frequency characteristics may be used. Local content dependent restriction of block encoding sizes may be used to improve performance of the video encoding. Specifically, the invention allows for an encoding block size to be set so as to result in high texture information being preserved for picture regions having a spatial frequency characteristic that indicates high levels of texture. Thus, the invention enables a significant reduction in the loss of texture information and thus mitigates the plastification or texture smearing effect encountered in many video encoders, including for example H.264 video encoders. Alternatively and additionally, the invention allows for an encoding block size to be set so as to result in reduced block based coding artefacts (e.g. blocking artefacts) for picture regions having a spatial frequency characteristic that indicates a high degree of flatness. Thus, the invention enables a significant reduction in the coding imperfections encountered in many video encoders, including for example H.264 video encoders.

According to a feature of the invention, the encoding block size is a motion estimation block size. The invention thus enables an optimisation of a motion estimation block size to suit the local spatial frequency characteristic of a picture region.

According to another feature of the invention, the means for determining the picture region is operable to determine the picture region as a group of pixels for which the spatial frequency characteristic meets a spatial frequency criterion. A picture region may be determined such that it has the same or similar spatial frequency properties and thus be suited for the same encoding block size. The spatial frequency criterion may be directly associated with a given encoding block size. For example, a picture region may be determined as one or more picture areas for which the spatial frequency characteristic meets a given characteristic corresponding to a predetermined encoding block size.

According to another feature of the invention, the spatial frequency criterion is that a spatial frequency distribution comprises an energy concentration above an energy threshold for spatial frequencies below a frequency threshold. A high concentration of low frequency components is indicative of a high degree of flatness of the picture. It has been observed that coding artefacts related to block sizes, such as blocking artefacts, often occurs in areas of high levels of flatness. This may be mitigated by appropriate selection of encoding block size. Hence, the mitigation of the coding artefacts and imperfections may be facilitated and/or increased. The frequency properties associated with the spatial frequency characteristic may for example be performed by a frequency analysis, such as a Discrete Cosine Transform (DCT), or by determining a variance measure of surrounding pixels.

According to another feature of the invention, the means for setting the encoding block size is operable to set the encoding block size to a predetermined value. This allows for a simple and easy to implement way of setting the encoding block size. A plurality of encoding block size values may be predetermined and associated with specific spatial frequency characteristics. A look-up table may for example be used to correlate a spatial frequency characteristic with a predetermined encoding block size.

According to another feature of the invention, the means for determining the picture region comprises means for determining the spatial frequency characteristic in response to a variance of pixel values within the picture region. This provides a good indication of the spatial frequency characteristic of a picture region yet is easy to implement and does not require any transforms.

According to another feature of the invention, the means for setting the encoding block size comprises means for generating a set of allowable encoding block sizes in response to the spatial frequency characteristic; and the means for encoding comprises means for selecting the encoding block size from the set of allowable encoding block sizes. The video encoding may use a encoding block size set in response to many parameters of which the spatial frequency characteristic is one. Specifically, the spatial frequency characteristic may be used to restrict the possible encoding block sizes to a limited set from which an encoding block size can be selected in response to other parameters. This allows a flexible selection of encoding block size to suit the video encoding, yet allows the performance of the video encoder to be controlled in response to the spatial frequency characteristic.

According to another feature of the invention, the video encoder further comprises: means for determining a second picture region having a second spatial frequency characteristic; means for setting a second encoding block size for the second picture region in response to the second spatial frequency characteristic; and wherein the means for encoding the video signal is operable to encode the video signal using the second encoding block size for the second picture region. The means for processing the second picture region may be the same means for processing the first picture region. The picture regions may for example be processed in parallel in different functional modules or sequentially in the same functional module. Preferably a plurality of picture regions is determined and the encoding block size is set for each picture region to suit the spatial frequency characteristic of that region. This allows for the encoding block size and to be optimised for the local spatial frequency characteristics and thus for an improved video encoding.

According to another feature of the invention, the spatial frequency characteristic comprises an indication of a degree of flatness in the picture region and the means for setting the encoding block size is operable to increase the encoding block size for increasing degrees of flatness. Picture areas having high degrees of flatness have been observed to be sensitive to coding imperfections such as block based coding artefacts. Block based artefacts may for example be blocking artefacts. The inventors of the present invention have realised that this effect may be mitigated by increasing the encoding block size. Accordingly, an improved video encoding quality may be obtained.

According to another feature of the invention, the spatial frequency characteristic comprises an indication of a degree of uniformity in the picture region and the means for setting the encoding block size is operable to increase the encoding block size for increasing degrees of uniformity. Picture areas having high degrees of uniformity have been observed to be sensitive to coding imperfections such as texture loss or smearing. The inventors of the present invention have realised that this effect may be mitigated by increasing the encoding block size. Accordingly, a reduced texture loss or smearing may be achieved, and thus an improved video encoding quality may be obtained.

According to another feature of the invention, the spatial frequency characteristic comprises an indication of a concentration of energy towards lower frequencies and the means for setting the encoding block size is operable to increase the encoding block size for an increasing concentration of energy towards lower frequencies. A concentration of energy towards low frequencies may indicate a high degree of flatness and a susceptibility to coding imperfections in the video encoding, and this may be mitigated by selection of larger encoding block sizes.

According to another feature of the invention, the video encoder further comprises: means for setting a quantisation level for the picture region in response to the spatial frequency characteristic; and the means for encoding the video signal is operable to use the quantisation level for the picture region. The performance of the video encoder may furthermore be improved by setting both a quantisation level and an encoding block size in response to the spatial frequency characteristic. The combined effect of quantisation levels and encoding block sizes on video encoding artefacts such as texture loss or block based coding artefacts is significant and highly correlated. Therefore, performance may be improved by adjusting both parameters in response to the spatial frequency characteristic of a picture region.

According to another feature of the invention, the video encoder is a video encoder in accordance with the H.264 recommendation defined by the International Telecommunications Union. The invention thus enables an improved video encoder which is operable to work and exploit the options and restrictions of the H.264 standard. H.264 is jointly developed by ITU-T (International Telecommunication Union—Telecommunication Standardization Sector) and ISO/IEC (the International Organization for Standardization/the International Electrotechnical Committee). ITU-T Rec. H.264 is equivalent to ISO/IEC 14496-10 AVC.

According to another feature of the invention, the encoding block size is selected from a set of motion estimate block sizes of inter prediction modes defined in the H.264 standard. Thus, the invention enables an improved H.264 video encoder wherein the selection of standardised encoding block sizes is controlled so as to suit a local spatial frequency characteristic.

According to a second aspect of the invention, there is provided a method of video encoding comprising the steps of: determining a picture region having a spatial frequency characteristic; setting an encoding block size for the picture region in response to the spatial frequency characteristic; and encoding the video signal using the encoding block size for the picture region.

These and other aspects, features and advantages of the invention will be apparent from and elucidated with reference to the embodiment(s) described hereinafter.

### BRIEF DESCRIPTION OF THE DRAWINGS

An embodiment of the invention will be described, by way of example only, with reference to the drawings, in which:

FIG. 1 illustrates the possible partitioning of macro-blocks into motion estimation blocks in accordance with the H.264 standard;

FIG. 2 illustrates a block diagram of a video encoder in accordance with an embodiment of the invention; and

FIG. 3 illustrates a flow chart of a method of video encoding in accordance with an embodiment of the invention.

### DESCRIPTION OF PREFERRED EMBODIMENTS

The following description focuses on an embodiment of the invention applicable to video encoding in accordance with the H.26L, H.264 or MPEG-4 AVC video encoding standards. However, it will be appreciated that the invention is not limited to this application but may be applied to many other video encoding algorithms, specifications or standards.

Most established video coding standards (e.g. MPEG-2) inherently use block-based motion compensation as a practical method of exploiting correlation between subsequent pictures in video. This method attempts to predict each macro-block (16×16 pixels) in a certain picture by its “best match” in an adjacent reference picture. If the pixel-wise difference between a macro-block and its prediction is small enough, this difference is encoded rather than the macro-block itself. The relative displacement of the prediction block with respect to the coordinates of the actual macro-block is indicated by a motion vector, which is coded separately.

New video coding standards such as H.26L, H.264 or MPEG-4 AVC promise improved video encoding performance in terms of an improved quality to data rate ratio. Much of the data rate reduction offered by these standards can be attributed to improved methods of motion compensation. These methods mostly extend the basic principles of previous standards, such as MPEG-2.

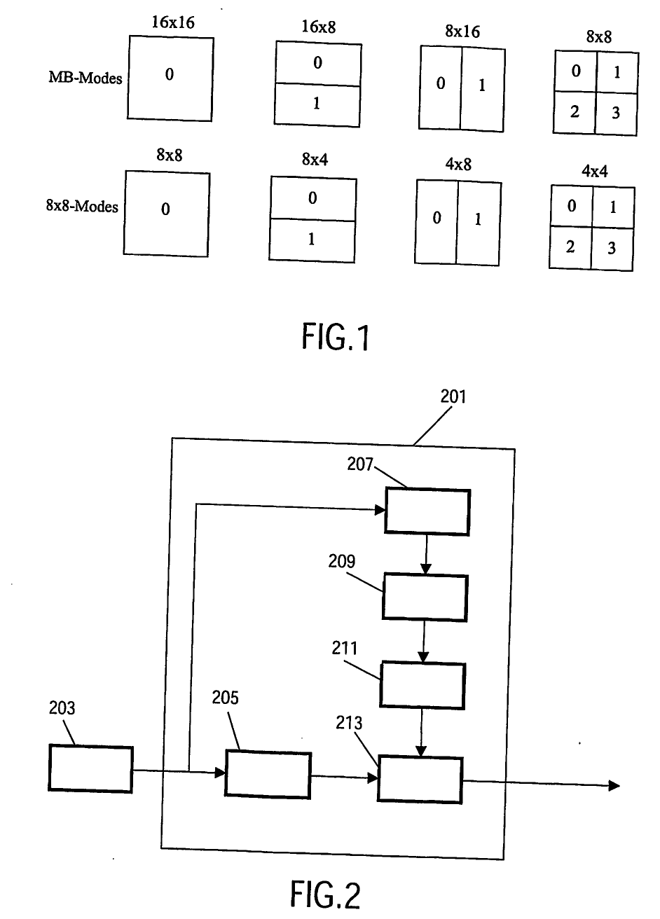

One relevant extension is the use of multiple reference pictures for prediction, whereby a prediction block may originate in more distant (the distance is currently unrestricted) future- or past pictures. Another and even more efficient extension is the possibility of using variable block sizes for prediction of a macro-block. Accordingly, a macro-block (still 16×16 pixels) may be partitioned into a number of smaller blocks and each of these sub-blocks can be predicted separately. Hence, different sub-blocks can have different motion vectors and can be retrieved from different reference pictures. The number, size and orientation of prediction blocks are uniquely determined by definition of inter prediction modes, which describe possible partitioning of a macro-block into 8×8 blocks and further partitioning of each of the 8×8 sub-block. FIG. 1 illustrates the possible partitioning of macro-blocks into motion estimation blocks in accordance with the H.264 standard.

Various experiments with video encoding according to H.264 have demonstrated that the use of multiple reference pictures and especially smaller prediction blocks can lead to significant bit-rate reductions for the same quality level. However, it has also been observed that that while H.264 can significantly reduce some typical artefacts of MPEG-2 video encoding, it can also cause other artefacts. One such artefact is a partial removal of texture, resulting in texture smearing and a plastic-like appearance of some picture areas. Another artefact is noise in static areas with little detail. The artefacts are most noticeable in large areas with little detail or variation and is especially noticeable for larger picture formats, such as High Definition TV.

The inventors of the current invention have realised that the coding artefacts are affected by the encoding block size used, and that it may be mitigated by improved selection of encoding block sizes.

FIG. 2 illustrates a block diagram of a video encoder 201 in accordance with an embodiment of the invention.

The video encoder 201 is coupled to an external video source 203 from which a video signal to be encoded is received. The video signal comprises a number of pictures or frames.

The video encoder 201 comprises a buffer 205 coupled to the external video source 203. The buffer 205 receives the video signal from the external video source 203 and stores one or more pictures or frames until the video encoder 201 is ready to encode them. The external video source 203 is furthermore coupled to a segmentation processor 207. The segmentation processor 207 is operable to determine a picture region by dividing the picture into different picture regions. The picture may be divided into two or more picture regions in response to any suitable algorithm or criterion and specifically the picture may be divided into two picture regions by selecting a single picture region for which a given criterion is met.

The segmentation processor 207 is coupled to a characteristics processor 209. The characteristics processor 209 is operable to determine a spatial frequency characteristic for the picture region determined by the segmentation processor 207. The spatial frequency characteristic may for example indicate a spatial frequency domain energy distribution for the determined picture region. For example, the spatial frequency characteristic may indicate the concentration of energy below a given frequency threshold.

In other embodiments, no specific segmentation is performed in the segmentation processor 207. Rather, the video signal to be encoded is fed to the characteristics processor 209 in predetermined picture regions. Specifically, individual macro-blocks may be fed directly from the external video source 203 or the buffer 205 to the characteristics processor 209. In this embodiment the picture region is directly generated by receiving or retrieving a single macro-block an processing this.

In the preferred embodiment, the spatial frequency characteristic comprises and indication of a degree of flatness and/or uniformity of the determined picture region.

A region in a picture is generally considered uniform if it lacks texture/detail or if it contains texture that is stationary, i.e. has uniform variation. A flat region is generally considered a region that simply lacks texture and/or detail and thus has relatively low concentrations of high frequent content. A typical flat region thus appears flat to a viewer. A typical example of flat regions is regions of uniform colour in cartoons. The term uniform is generally considered to be broader than flat and thus typically a flat region is also considered flat (but not necessarily vice versa).

In regions that have low variation, such as uniform or flat regions, deviations are much easier noticed. Hence, coding imperfections and artefacts may be particularly disadvantageous in these regions. For example, a significant problem with flat areas is that they are characterized by low frequent content to which the human eye is more responsive and therefore also more sensitive to artefacts. Moreover, flat areas often correspond to more static objects or the background in a scene (e.g. walls, sky, etc.), where the human eye has more time to focus.

To reduce the data rate, most video coders rely on the property of the human eye to be relatively less sensitive to high frequency content, and accordingly the video coders include mechanisms for suppressing higher frequencies in the spectrum of a video signal. With standard block-based coders, this is mostly achieved through block transforms and weighting and quantization of the transform coefficients, which are designed in such that lower order coefficients are preserved at the cost of the higher order coefficients.

The inventors have realised that in flat areas coding artefacts related to block based coding can be particularly disturbing. Such artefacts may occur in conventional coders due to inconsistent selection of encoding block sizes and the corresponding quantization levels.

The inventors have further realised that the partial texture loss or smearing typical of conventional encoders are affected by the selection of encoding block sizes. A possible explanation for the removal of texture, which is of a predominantly high frequency nature, is that in H.264, a 16×16 macro-block may be transformed using a 4×4 block transform. In contrast, MPEG-2 uses an 8×8 DCT transform for the same purpose. Accordingly, by using smaller transform blocks, H.264 compacts signal energy into a larger number of low frequency coefficients, leaving a smaller number of high frequency coefficients that are more susceptible to be suppressed during the consecutive video encoding (for example due to coefficient weighting or quantization). As texture information is typically of a relatively high frequency nature, a loss of texture results.

In a simple embodiment, the spatial frequency characteristic may be a single binary parameter which indicates if a given criterion is met. For example, the spatial frequency characteristic may be set to zero if, say, more than 60% of the signal energy is contained within the lowest 20% of the relevant frequency spectrum and to one otherwise. In this case, a spatial frequency characteristic value of zero indicates a high concentration of energy towards the lower frequencies. This is an indication of the picture region having a high degree of flatness, and therefore indicating that the picture region has a high susceptibility to coding artefacts when being encoded.

The characteristics processor 209 is coupled to a coding controller 211. The coding controller 211 is operable to set an encoding block size for the picture region in response to the spatial frequency characteristic. In the preferred embodiment, the encoding block size is a motion estimation block size and is specifically a prediction block size as allowed by the inter prediction modes defined in the H.264 video encoding standard.

In the simple embodiment mentioned above, the encoding block size may be set to a first block size if the spatial frequency characteristic is zero and to a second block size if the spatial frequency characteristic is a one. Thus, in some embodiments, the coding controller 211 may simply set the encoding block size by selecting a predetermined block size in response to a predetermined association between values of the spatial frequency characteristic and the encoding block sizes.

The coding controller 211 is coupled to an encode processor 213 which is furthermore coupled to the buffer 205. The encode processor 213 is operable to encode the picture stored in the buffer 205 using the encoding block size set by the coding controller 211 for the picture region determined by the segmentation processor 207. Thus, the video encoding will be such that the encoding block size for the picture region is specifically adapted to suit the spatial frequency characteristic of that picture region. For example, in the simple embodiment described, a concentration of signal energy towards lower spatial frequencies will result in a first larger block size being used. Otherwise a lower block size will be used or at least permitted thereby allowing for improved encoding efficiency. Hence, if the spatial frequency characteristic comprises an indication of a high degree of flatness (and thus a sensitivity to coding artefacts) larger encoding block sizes are used, thereby mitigating or eliminating the coding imperfections. In the preferred embodiment, the encoding processor 213 is operable to encode the video signal in accordance with the H.264 video encoding standard.

An embodiment particularly suited for easy implementation is where the picture regions correspond to one macro block. In this embodiment, the macro-blocks are directly fed to the characteristics processor 209 which then determines the spatial frequency characteristics of that macro-block. In response, the coding controller 211 determines a suitable encoding block size for that macro-block, and possibly on a number of neighboring macro-blocks.

The encoding processor 213 receives the macro-block from the buffer 205 and encodes it using the encode block size selected for the macro-block by the coding controller. This enables parallel, and therefore more efficient execution in hardware.

Furthermore, the characteristic processor (209) may store the spatial frequency characteristics obtained for macro-blocks from subsequent pictures. This would enable an analysis of time-consistency of spatial spectral characteristics that can further be used to optimize the selection of encoding parameters. For example it may facilitate discrimination between texture of the underlying picture and texture origination from noise of the video source (e.g. the so-called “film grain” in movies).

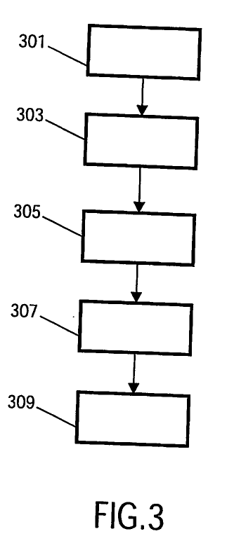

FIG. 3 illustrates a flow chart of a method of video encoding in accordance with an embodiment of the invention. The method is applicable to the video encoder 201 of FIG. 2 and will be described with reference to this.

In step 301, the video encoder 201 receives the video signal to be encoded from the external video source.

Step 301 is followed by step 303 wherein the segmentation processor 207 determines a picture region. The picture region may be determined in accordance with any suitable criterion or algorithm. In a simple embodiment, a single picture region may be selected in accordance with a criterion and the picture is divided into just two picture regions consisting in the selected picture region and a picture region comprising the remainder of the picture. However, in the preferred embodiment the picture is divided into several picture regions.

In the preferred embodiment, the picture is divided into picture regions by segmentation of the picture. In the preferred embodiment, picture segmentation comprises the process of a spatial grouping of pixels based on a common property (e.g. colour). There exist several approaches to picture- and video segmentation, and the effectiveness of each will generally depend on the application. It will be appreciated that any known method or algorithm for segmentation of a picture may be used without detracting from the invention.

An introduction to picture or video segmentation may be found in for example E. Steinbach, P. Eisert, B. Girod, “Motion-based Analysis and Segmentation of Image Sequences using 3-D Scene Models,” Signal Processing: Special Issue: Video Sequence Segmentation for Content-based Processing and Manipulation, vol. 66, no. 2, pp. 233-248, IEEE 1998 or A. Bovik: Handbook of Image and Video Processing, Academic Press. 2000.

In the preferred embodiment, the segmentation includes detecting an object in response to a common characteristic, such as a colour or a level of uniformity, and consequently tracking this object from one picture to the next. This provides for simplified segmentation and facilitates identification of suitable regions for being encoded with the same encoding block size. As an example, an initial picture may segmented and the obtained segments tracked across subsequent pictures, until a new picture is segmented independently, etc. The segment tracking is preferably performed by employing known motion estimation techniques.

In the preferred embodiment, the picture regions may comprise a plurality of picture areas which are suitable for similar choices of video encoding parameters and in particular encoding block size. Thus, a picture region may be formed by grouping of a plurality of segments. For example, if the video signal corresponds to a football match, all regions having a predominantly green colour may be grouped together as one picture region.

As another example, all segments having a predominant colour corresponding to the colour of the shirts of one of the teams may be grouped together as one picture region. The picture segments need not necessarily correspond to physical objects. For example, two neighbouring segments may represent different objects but may both be highly textured. In this case, both segments may be suited for the same encoding block size.

In a specific embodiment, the picture region or regions may specifically be determined in response to properties or characteristics of the picture. Specifically, the picture regions may be determined in response to a spatial frequency characteristic. Thus, the segmentation processor 207 may be operable to determine the picture region as a group of pixels for which the spatial frequency characteristic meets a spatial frequency criterion. For example, a picture region may be determined by grouping all e.g. 4×4 pixel blocks for which 50% of the energy are contained in the three DCT coefficients corresponding to the lowest spatial frequencies. A second picture region may be determined by grouping all remaining 4×4 pixel blocks for which 50% of the energy is contained in the six DCT coefficients corresponding to the lowest spatial frequencies. A third picture region may be formed by the remaining 4×4 pixel blocks.

In other embodiments, the picture may simply be divided into a number of picture regions without consideration of the properties of the picture. For example, a picture may simply be divided into a number of adjacent squares of a suitable size.

In yet other embodiments, the method does not comprise a step of segmenting 301, or equivalently the segmentation step simply comprises in retrieving or receiving a picture region such as a block to be encoded and specifically a macro-block may be received.

Step 303 is followed by step 305 wherein a spatial frequency characteristic of the picture region is determined by the characteristics processor 209. In the preferred embodiment, a spatial frequency characteristic indicative of the uniformity or flatness of the picture region is determined. One such measure is a spatial frequency distribution wherein a concentration of energy towards the lower frequencies indicates an increased flatness. In one embodiment, the spatial frequency characteristic may be determined by performing a Discrete Cosine Transform (DCT) on one or more blocks within the picture region. For example, a 4×4 DCT may be performed for all 4×4 pixel blocks in the picture region. The DCT coefficient values may be averaged for all the blocks in the picture region and the spatial frequency characteristic may comprise the averaged coefficient values or an indication of the relative magnitude of the different coefficient values.

Another method of determining a measure for flatness is by determining a variance of pixel values within the picture region. This variance may not only be a statistical variance but may also be any other measure of the variation or spread of pixel values within the picture region. The variance or spread may be calculated by taking the average of a pixel and the surrounding pixels and then measuring the difference between the pixels and the average value. This is particularly suitable for an embodiment wherein each picture region corresponds to one or more macro-blocks.

It will be appreciated that the combined effect of step 303 and 305 is to determine a picture region having a spatial frequency characteristic. This may for example be done by determining a picture region in accordance with a given criterion and subsequently determining a spatial frequency characteristic for that region. Alternatively or additionally, a picture region may directly be determined e.g. by grouping picture areas or sections that have a given spatial frequency characteristic. In this case no specific analysis of the picture region is necessary to determine the spatial frequency characteristic as it is inherently given by the determination of the picture region.

Step 307 is followed by step 305 wherein the coding controller 211 sets an encoding block size for the picture region in response to the spatial frequency characteristic.

In some embodiments, the encoding block size is set to a predetermined value. For example, the spatial frequency characteristic may consist in a single measure of the concentration of energy below a given frequency threshold. The coding controller 211 may comprise a look-up table wherein if the energy concentration is below a first value of say 50%, a first predetermined encoding block size is set, if the energy concentration is below a second value of say 75%, a second predetermined encoding block size is set, and otherwise a third predetermined encoding block size is set.

In the preferred embodiment, the spatial frequency characteristic comprises an indication of a degree of flatness or uniformity in the picture region and the coding controller 211 is operable to set the encoding block size such that the encoding block size increases for increasing degrees of flatness or uniformity. In the previous example, the first predetermined encoding block size is smaller than the second predetermined encoding block size which again is smaller than the third predetermined encoding block size. This may reduce texture removal or smearing for critical picture areas as larger encoding block size causes less texture loss than smaller encoding block sizes.

In some embodiments, the encoding block size may comprise a group of allowable values for the encoding block size. Hence, in some cases, a specific parameter value may be selected for the encoding block size, whereas in other embodiments an encoding block size having a range of allowable values may be selected. Accordingly, the encoding block size provides a constraint or restriction for the choice of encoding parameters for the consequent video encoding. Thus, in the preferred embodiment, the coding controller 211 controls or influences the operation of the encode processor 213. Thus, rather, than a single encoding block size value being selected by the coding controller 211, a set of allowable encoding block sizes may be selected or set by the coding controller 211. The encode processor 213 may then encode the video signal by selecting an encoding block size from the set determined by the coding controller 211. Hence, in some embodiments, the coding controller 211 is operable to generate a set of allowable encoding block sizes in response to the spatial frequency characteristic and the encode processor 213 is operable to select the encoding block size from the set of allowable encoding block sizes.

In some embodiments, where each picture region corresponds to one or more macro-block, the selection of encoding block size preferably comprises partitioning macro-blocks into motion estimation blocks in accordance with the H.264 standard.

Step 307 is followed by step 309 wherein the video signal is encoded in the encode processor 213 using the encoding block size determined by the coding controller 211. In the preferred embodiment, the video encoding is in accordance with the H.264 video encoding standard.

Specifically, the method of a preferred embodiment may thus reduce the blocking artefacts in pictures which are encoded with the use of H.26L1-like techniques of motion compensation, i.e. with the use of variable block size during inter-frame prediction. The method of the embodiment identifies flat areas in a picture and enforces a constraint on the encoding block size in those areas. Particularly, it is enforced that larger prediction blocks are used. The required discrimination of regions based on their flatness can be performed during encoding, but it can also be available beforehand (e.g. if needed for other applications). The complexity of such analysis (in the case of performing picture segmentation) may in some cases be a restrictive factor for real-time implementation. The method of the preferred embodiment is particularly but not exclusively suited for non-real time applications, such as video streaming, broadcast or publishing.

In the preferred embodiment, the coding controller 211 is furthermore operable to set a quantisation level for the picture region in response to the spatial frequency characteristic, and the encode processor 213 is operable to use the quantisation level for the picture region. For example, a quantisation threshold may be set below which all coefficients following an encoding DCT are set to zero. A lower threshold may result in reduced data rates but also reduced picture quality. The texture loss is increased for increasing thresholds and accordingly, the quantisation level is preferably lowered in line with the encoding block size being increased in order to further mitigate the texture smearing effect.

In the preferred embodiment, the encoding block size set is a motion estimation prediction block size. However, it will be appreciated that other encoding block sizes may be set in response to the spatial frequency characteristic. For example, the transformation size used for transforming video data into spatial frequencies may be set in response to the spatial frequency characteristic. Furthermore, more than one block size may be set in response to the spatial frequency characteristic. For example, in some embodiments it may be advantageous to set both a prediction block size and a transform block size in response to the spatial frequency characteristic and in particular to set these to tile same block size.

The steps of the method may be iterated for different picture regions or different regions may be processed in each of the steps.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

1. A video encoder (201) for encoding a video signal comprising:
means (207, 209) for determining a picture region having a spatial frequency characteristic;
means (211) for setting an encoding block size for the picture region in response to the spatial frequency characteristic; and
means (213) for encoding the video signal using the encoding block size for the picture region.

2. A video encoder (201) as claimed in claim 1 wherein the encoding block size is a motion estimation block size.

3. A video encoder (201) as claimed in claim 1 wherein the means (207, 209) for determining the picture region is operable to determine the picture region as a group of pixels for which the spatial frequency characteristic meets a spatial frequency criterion.

4. A video encoder (201) as claimed in claim 3 wherein the spatial frequency criterion is that a spatial frequency distribution comprises an energy concentration above an energy threshold for spatial frequencies below a frequency threshold.

5. A video encoder (201) as claimed in claim 3 wherein the means (211) for setting the encoding block size is operable to set the encoding block size to a predetermined value.

6. A video encoder (201) as claimed in claim 1 wherein the means (207, 209) for determining the picture region comprises means for determining the spatial frequency characteristic in response to a variance of pixel values within the picture region.

7. A video encoder (201) as claimed in claim 1 wherein the means (211) for setting the encoding block size comprises means for generating a set of allowable encoding block sizes in response to the spatial frequency characteristic; and the means (213) for encoding comprises means for selecting the encoding block size from the set of allowable encoding block sizes.

8. A video encoder (201) as claimed in claim 1 further comprising:
means for determining a second picture region having a second spatial frequency characteristic;
means for setting a second encoding block size for the second picture region in response to the second spatial frequency characteristic; and wherein
the means (213) for encoding the video signal is operable to encode the video signal using the second encoding block size for the second picture region.

9. A video encoder (201) as claimed in claim 1 wherein the spatial frequency characteristic comprises an indication of a degree of flatness in the picture region and the means (211) for setting the encoding block size is operable to increase the encoding block size for increasing degrees of flatness.

10. A video encoder (201) as claimed in claim 1 wherein the spatial frequency characteristic comprises an indication of a degree of uniformity in the picture region and the means (211) for setting the encoding block size is operable to increase the encoding block size for increasing degrees of uniformity.

11. A video encoder (201) as claimed in claim 1 wherein the spatial frequency characteristic comprises an indication of a concentration of energy towards lower frequencies and the means (211) for setting the encoding block size is operable to increase the encoding block size for an increasing concentration of energy towards lower frequencies.

12. A video encoder (201) as claimed in claim 1 further comprising: means for setting a quantisation level for the picture region in response to the spatial frequency characteristic; and wherein the means (213) for encoding the video signal is operable to use the quantisation level for the picture region.

13. A video encoder (201) as claimed in claim 1 wherein the video encoder (201) is a video encoder in accordance with the H.264 recommendation defined by the International Telecommunications Union.

14. A video encoder (201) as claimed in claim 13 wherein the encoding block size is selected from a set of motion estimate block sizes of inter prediction modes defined in the H.26L standard.

15. A method of video encoding (300) comprising the steps of:
determining (303, 305) a picture region having a spatial frequency characteristic;
setting (307) an encoding block size for the picture region in response to the spatial frequency characteristic; and
encoding (309) the video signal using the encoding block size for the picture region.

16. A computer program enabling the carrying out of a method according to claim 15.

17. A record carrier comprising a computer program as claimed in claim 16.
